(19) United States
(12) Patent Application Publication
(10) Pub. No.: US 2007/0093223 A1
(43) Pub. Date: Apr. 26, 2007

(54) AM receiver

(75) Inventors: Takamichi Kuga, Osaka (JP); Yasuhisa Yao, Hyogo (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 11/582,501

(22) Filed: Oct. 18, 2006

(30) Foreign Application Priority Data
Oct. 20, 2005 (JP) 2005-305503

(51) Int. Cl. H04B 7/00

(52) U.S. Cl. 455/234.1

(57) ABSTRACT

To attain the object of providing an AM receiver capable of accurately recognizing an antenna input level, a DC voltage which indicates the status of RFAGC performance is outputted from an analog RF circuit block at the time of the RFAGC performance. Then the DC voltage is subjected to analog-to-digital conversion to obtain a digital value. This digital value is added to a digital value corresponding to an electric field strength detected at a digital IF circuit block and the result of the addition is outputted as a field-strength output. On account of this, its sensitivity to the detection of a broadcasting station is improved at the time of an automatic station selection.

### BACKGROUND OF THE INVENTION

1. Field of the Invention

The present invention relates to an AM receiver such as an AM radio receiver comprised of an analog RF circuit block with an AGC function and a digital IF circuit block provided with a field-strength meter.

2. Background Art

Receivers which receive AM signals generally use a superheterodyne method. The term “superheterodyne method” refers to a method in which a signal from a broadcasting station is mixed with a signal from a local oscillation circuit, the resulting signal is converted to an intermediate-frequency signal with a single frequency, and the intermediate-frequency signal is demodulated. The superheterodyne method has advantages that interference waves are easily attenuated (crosstalk is easily prevented), reception sensitivity is excellent owing to repeats of amplification, and so on because a single frequency can be used as a filter.

In AM reception processing, a configuration has been generally used in which the above superheterodyne method is implemented by using only an analog circuit. However, with the advance of a digital signal processing technique in which excellent anti-noise characteristics are exhibited, a digital IF technique is created in which an intermediate-frequency signal (IF) is converted to a digital signal by an A/D converter and the digital signal is detected by a digital detector to give an AM audio signal with an excellent signal-to-noise ratio (SN ratio) (see, for example, JP-A No. 2005-79677).

With an AM modulating signal, when the AM modulating signal is inputted to an IC for AM demodulation with the level of the signal exceeding the dynamic range of a circuit, a desired good-quality audio signal cannot be obtained due to the waveform distortion of the signal. Because of this, control is performed so that a signal at a certain level or higher is not inputted to the IC for AM demodulation during a high input by means of an AGC function. Therefore an electric field strength which indicates a signal level takes on a constant value at all times while the AGC function operates.

An example of conventional AM radio receivers using digital IF signals will be shown below with reference to FIG. 6.

As shown in FIG. 6, the conventional AM radio receiver comprises an analog RF circuit block 100, a digital IF circuit block 200, an antenna 1, a RF amplifier 2, a mixer 3, an IF unit 4, an A/D converter 5, an AM detector 6, a local oscillator 7, a RFAGC circuit 15, a field-strength meter 10, an AM audio signal output terminal 12, and a field-strength output terminal 13.

An AM modulating signal received from the antenna 1 is amplified by the RF amplifier 2 and the amplified signal is converted to an intermediate-frequency signal by the mixer 3. Then its interference waves are attenuated by the IF unit 4, the intermediate-frequency signal is inputted to the A/D converter 5 with its desired wave controlled to an optimum level, and the signal is converted to an intermediate-frequency digital signal. The intermediate-frequency digital signal, which is the output of the A/D converter 5, is digitally detected by the AM detector 6 and an AM audio signal is outputted from the AM audio signal output terminal 12.

And further, the AM radio receiver shown in FIG. 6 is provided with the field-strength meter 10 and an AGC function offered by the RFAGC circuit 15. A field-strength signal is produced by the field-strength meter 10 in the digital IF block 200 and outputted from the field-strength output terminal 13 as a digital signal.

Still further, the amplitude level of the intermediate-frequency signal is detected by means of the AGC function performed at the RFAGC circuit 15. When the amplitude level exceeds a threshold value, AGC is performed to reduce the amplification factor of the RF amplifier 2. Such performance will be described below in detail with reference to FIG. 7.

Incidentally, a signal line from the IF unit 4 to the A/D converter 5 is provided separately from a signal line from the IF unit 4 to the RFAGC circuit 15 and this reason is as follows: filtering and level adjustment are performed in response to the specifications of the A/D converter 5 and the RFAGC circuit 15 of the next stages, and therefore the signal lines are separately drawn. However, it is needless to say that a common signal line may be used.

FIG. 7 is a circuit diagram of concrete examples of the RFAGC circuit 15 and the RF amplifier 2 shown in FIG. 6. They comprise transistors Q1 to Q6, Q10, and Q11, resistors R1 to R3, capacitors C1 and C2, a coil L1, a constant-current source I1, a reference voltage V1, and a power supply Vcc.

An intermediate-frequency signal a is inputted to the base of the transistor Q1 and subjected to DC conversion by the capacitor C1 and the resistor R1 connected to the emitter of the transistor Q1. When the amplitude level of the intermediate-frequency signal a is low, the value of a DC voltage fed to the base of the transistor Q2 is low as well. Therefore the potential gradient at a comparator comprised of the constant-current source I1 and the transistors Q2 and Q3 is on the side of the transistor Q3, and hence the comparator operates in a direction in which no current flows to the transistor Q4. As a result, the transistors Q5 and Q6 are turned off and an AGC control voltage b is maintained high.

In contrast, when the amplitude level of the intermediate-frequency signal a heightens, the value of the DC voltage at the base of the transistor Q2 heightens and the potential gradient at the comparator moves to the side of the transistor Q4, thereby the transistors Q5 and Q6 operate one after the other. As a consequence, a current flows to the resistor R3 and the AGC control voltage b drops.

On the other hand, in the RF amplifier 2, an antenna input signal is inputted to the gate of the transistor Q11. Fluctuations in the level of the antenna input signal are converted to fluctuations in the drain-source current Ids of the transistor Q11. The antenna input signal is amplified at an amplification factor determined by the drain-source current Ids, the load of the coil L1, and the capacitance of the capacitor C2 and then inputted to the mixer 3.

The transistor Q10 controls a drain voltage at the transistor Q11; that is, variations in base voltage at the transistor Q10 brings about variations in the drain-source current Ids, and therefore the amplification factor is controlled. With an increase in the amplitude level of the intermediate-frequency signal a, that is, with a drop in the AGC control voltage b, the base voltage at the transistor Q10 of the RF amplifier 2 drops, the drain-source current Ids of the transistor Q11 decreases, and the amplification factor lowers.

Since the amplification factors of the mixer 3 and the IF unit 4 are constant irrespective of the AGC performance, the amplitude level of the intermediate-frequency signal a lowers with the AGC performance. The point of amplitude stability in the intermediate-frequency signal a is a point which indicates that the base voltage at the transistor Q2 has dropped to the reference voltage V1. At this point of time, the amplitude level of the intermediate-frequency signal a comes not to exceed a certain value. If a high level signal has been transiently inputted, the amplitude level of the intermediate-frequency signal a reaches the stability point again through the AGC loop performance.

The relationships between the antenna input levels and the field-strength outputs are shown in FIGS. 8A, 8B, and 8C. The horizontal axes indicate the antenna input levels, and the vertical axes indicate the field-strength outputs.

In FIG. 8A, a point X represents the point of the AGC performance. When a signal whose input level exceeds the value of the point X has been received from the antenna, the amplitude level of the intermediate-frequency signal becomes constant through the AGC performance, and the field-strength output takes on a constant value j without rising.

As one of the roles of the electric field strength, there is an automatic station selecting function performed by the AM radio receiver. This function is a station detecting function in which reception frequencies are swept and then the sweep of the reception frequencies is halted at one frequency at which a field-strength output exceeds a threshold value. As the threshold value of the electric field strength to be detected is set higher, the number of false detection of interference waves becomes fewer, but as the threshold value is set lower, the likelihood of false detection of interference waves becomes greater.

The setting of the threshold value by which the automatic station selecting function is established is shown in FIG. 8B. By setting the threshold value Th1 at a level lower than a value j at which the field-strength output becomes constant, the automatic station selecting function operates on an antenna input level above the value of a point Y.

However, when the AM radio receiver is in a radio wave status in which strong interference waves are included, the above RFAGC is also performed on the interference waves in order to suppress them. In the system of the conventional receiver, the electric field strength becomes constant after the RFAGC performance. Because of this, when the RFAGC performance has been done in a state that the input level of a desired station is low, a state arises in which the electric field strength does not heighten sufficiently. The operation of the automatic station selecting function performed under such a condition will be described below with reference to FIG. 8C. The electric field strength, which is denoted by using a letter k of FIG. 8C, represents a state in which the electric field strength of the desired station lowers as a whole because AGC has been performed on the interference waves. Therefore the level of the electric field strength cannot be determined at the threshold value Th1. As described above, the problem arises that as the threshold value Th1 is set higher, the sensitivity to the detection of a desired broadcasting station lowers.

### SUMMARY OF THE INVENTION

The present invention has been made in the light of the above problems, and therefore it is an object of the invention is to provide an AM radio receiver which comprises an analog RF circuit block and a digital IF circuit block and in which by conveying antenna input level information used during AGC performance from the analog RF circuit block to the digital IF circuit at the time of RFAGC performance, the linearity of an electric field strength effected during the RFAGC performance is secured and an improvement in sensitivity to the detection of a desired broadcasting station is therefore achieved.

In order to solve the above conventional problems, the AM receiver according to the invention includes a RFAGC monitor function for use in outputting a RFAGC monitor voltage (a DC voltage including the antenna input level information) which indicates the performance status of RFAGC at the time of the RFAGC performance and an A/D converter for use in digitally processing the RFAGC monitor voltage.

To be more specific, the AM receiver according to the invention includes a RF amplifier which amplifies a signal received by an antenna, a mixer which converts the amplified signal outputted by the RF amplifier to an intermediate-frequency signal, an IF unit which filters and amplifies the intermediate-frequency signal, the first A/D converter which converts the amplified signal outputted by the IF unit to an intermediate-frequency digital signal, an AM detection circuit which outputs an AM audio signal based on the output signal from the first A/D converter, a field-strength meter which converts the output signal from the first A/D converter to a first digital value corresponding to a DC voltage commensurate with the level of the intermediate-frequency signal, a RFAGC control circuit which combines a RFAGC function for use in controlling the amount of a signal attenuated at the RF amplifier in response to the level of the intermediate-frequency signal and the RFAGC monitor function for use in outputting a RFAGC monitor voltage which indicates the performance status of RFAGC, a second A/D converter which converts the RFAGC monitor voltage into a second digital value, an adder which adds the first digital value outputted from the field-strength meter and the second digital value outputted from the second A/D converter, and a terminal which outputs the result of the addition performed by the adder as an AM field-strength output.

Furthermore, since the power supply (Vcc) of the analog RF circuit block is generally higher than the power supply (VDD) of the digital IF circuit block in voltage, it is preferable that the AM receiver according to the invention have a voltage limiting function so that the RFAGC monitor voltage does not exceed a power supply voltage at the A/D converter. That is, it is preferable that the AM receiver have a maximum output limiter which limits the maximum value of the RFAGC monitor voltage between the RFAGC monitor voltage output unit of the RFAGC control circuit and the second A/D converter.

As described above, in the AM receiver according to the invention which comprises the analog RF circuit block and the digital IF circuit block, by adding the second digital value obtained by subjecting the RFAGC monitor voltage to the digital conversion to the first digital value representing the output of the field-strength meter, the linearity of the field-strength output to the input level is secured and the antenna input can be determined from the field-strength output irrespective of the RFAGC performance. As a result, the sensitivity of an automatic channel selection function is improved.

In addition, when the voltage limiting function is provided, the maximum output of the RFAGC monitor is limited and this makes it possible to avoid problems such as malfunction and withstand voltage caused by the excess of an input voltage to the A/D converter over the power supply voltage.

### BRIEF DESCRIPTION OF THE DRAWINGS

FIG. 1 is a block diagram of the configuration of an AM radio receiver according to a first embodiment of the present invention;

FIG. 2 is a block diagram of the configuration of an AM radio receiver according to a second embodiment of the invention;

FIG. 3 is a circuit diagram of an exemplary RFAGC circuit according to the first embodiment of the invention;

FIG. 4 is a circuit diagram of an exemplary RFAGC circuit according to the second embodiment of the invention;

FIGS. 5A to 5D are characteristic diagrams showing RFAGC monitoring and electric field strength described in the first embodiment of the invention;

FIG. 6 is a block diagram of the configuration of a conventional AM radio receiver;

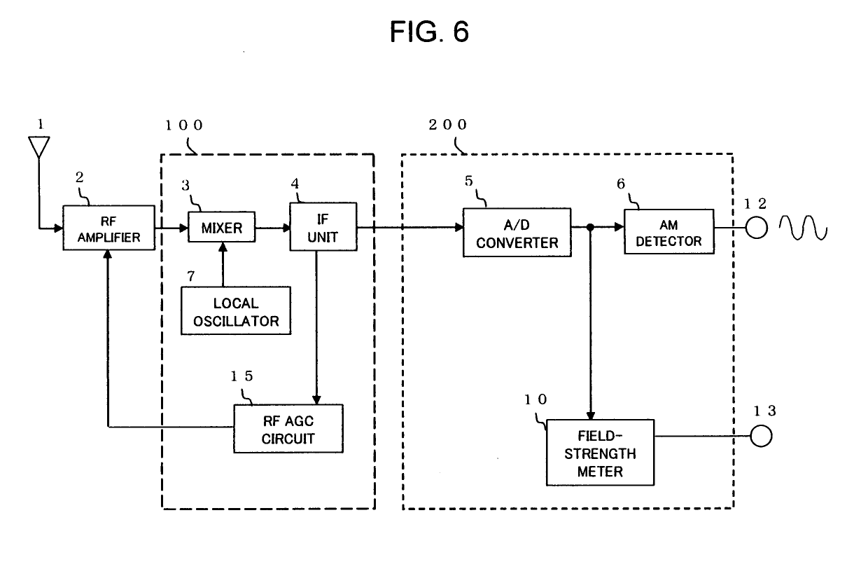

FIG. 7 is a circuit diagram of an exemplary RFAGC circuit included in the conventional AM radio receiver; and

FIGS. 8A to 8C are characteristic diagrams showing conventional electric field strength.

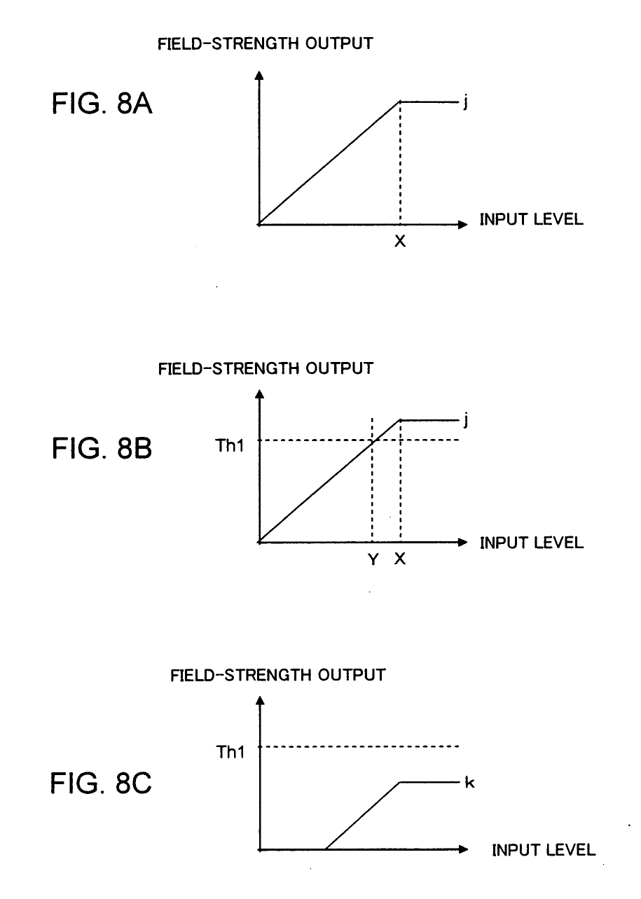

### DESCRIPTION OF THE EXEMPLARY EMBODIMENTS

Embodiments of the present invention will be described below with reference to the drawings.

### First Embodiment

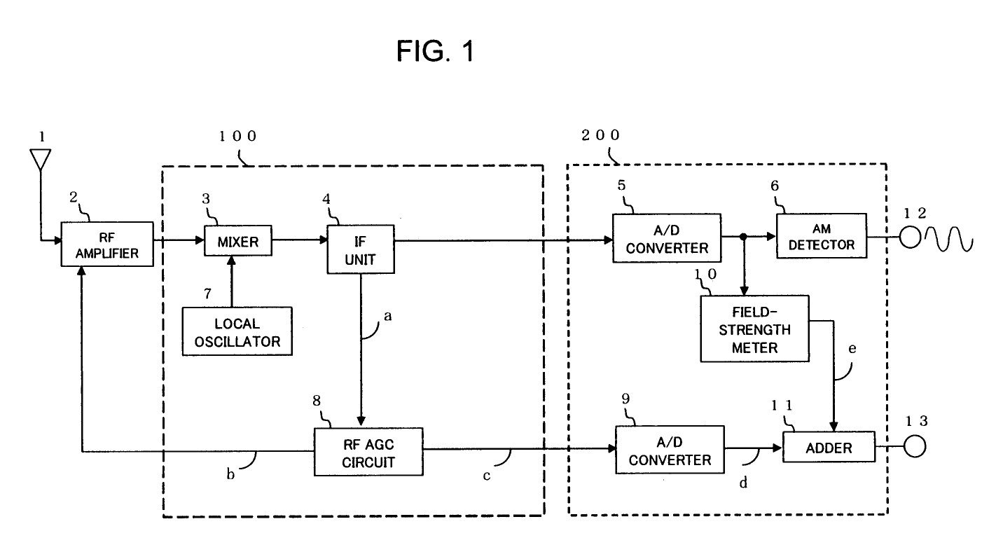

FIG. 1 is a block diagram of the configuration of an AM radio receiver according to a first embodiment of the invention. Components which are the same as those described in the above conventional example are represented by using the same reference numerals.

As shown in FIG. 1, the AM radio receiver comprises an analog RF circuit block 100, a digital IF circuit block 200, an antenna 1, a RF amplifier 2, a mixer 3, an IF unit 4, an A/D converter 5 for intermediate-frequency signals, an AM detector 6, a local oscillator 7, a RFAGC circuit 8, an AD converter 9, a field-strength meter 10, an adder 11, an AM audio signal output terminal 12, and a field-strength output terminal 13.

In FIG. 1, an AM modulating signal received from the antennal 1 is amplified by the RF amplifier 2 and the amplified signal is converted to an intermediate-frequency signal by the mixer 3. The intermediate-frequency signal, in which interference waves have been attenuated and the level of a desired wave has been optimally controlled by the IF unit 4, is inputted to the A/D converter 5 and converted to an intermediate-frequency digital signal. The intermediate-frequency digital signal, i.e., an output from the A/D converter 5 is digitally detected by the AM detector 6 and, thereafter, an AM audio signal is outputted from the AM audio signal output terminal 12.

On the other hand, AGC control is performed by the RFAGC circuit 8. Specifically, the amplitude level of an intermediate-frequency signal a is detected by the RFAGC circuit 8 and in response to that level, the RFAGC circuit 8 outputs an AGC control voltage b. The amplification factor of the RF amplifier 2 is reduced based on the AGC control voltage b. When the amplitude level of the intermediate-frequency signal a is below a threshold voltage, no DC voltage is outputted aside from the AGC control voltage b and when the amplitude level is above the threshold value, a DC voltage is outputted. Such a voltage is herein referred to as “RFAGC monitor voltage c”. The RFAGC monitor voltage c is a DC voltage which represents the performance status of RFAGC and as the input level of the antenna heightens, the RFAGC monitor voltage c increases. Because of this, it can be said that the RFAGC monitor voltage c is a DC voltage including antenna input level information.

The RFAGC monitor voltage c is outputted from the RFAGC circuit 8 and is converted to a digital signal by the A/D converter 9. With respect to field strength, a voltage e generated at the field-strength meter 10 through digital signal processing (a first digital value corresponding to a DC voltage commensurate with the amplitude level of an intermediate-frequency signal) and a voltage d obtained by digitally converting the RFAGC monitor voltage c (a second digital value) are added up by the adder 11 and the resulting voltage is outputted from the field-strength output terminal 13 as a field-strength output.

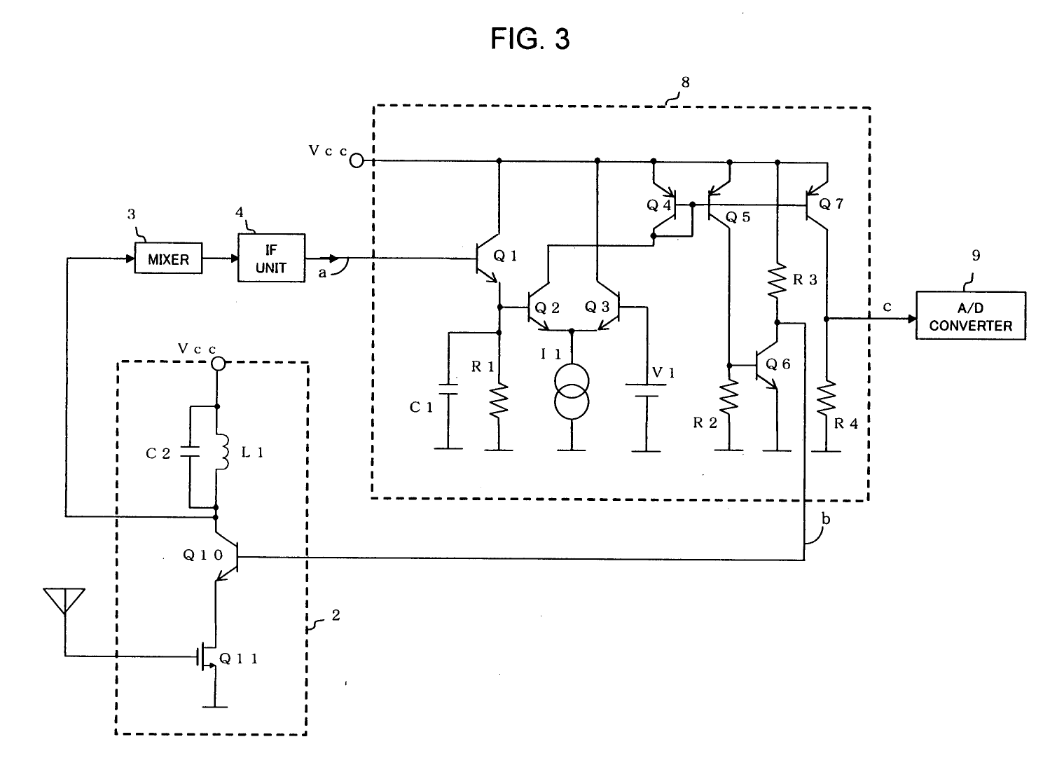

FIG. 3 is a circuit diagram of concrete examples of the configurations of the RFAGC circuit 8 and the RF amplifier 2 shown in FIG. 1. They comprises transistors Q1 to Q7, Q10, and Q11, resistors R1 to R4, capacitors C1 and C2, a coil L1, a constant-current source I1, a reference voltage V1, and a power supply Vcc and their operations will be described below.

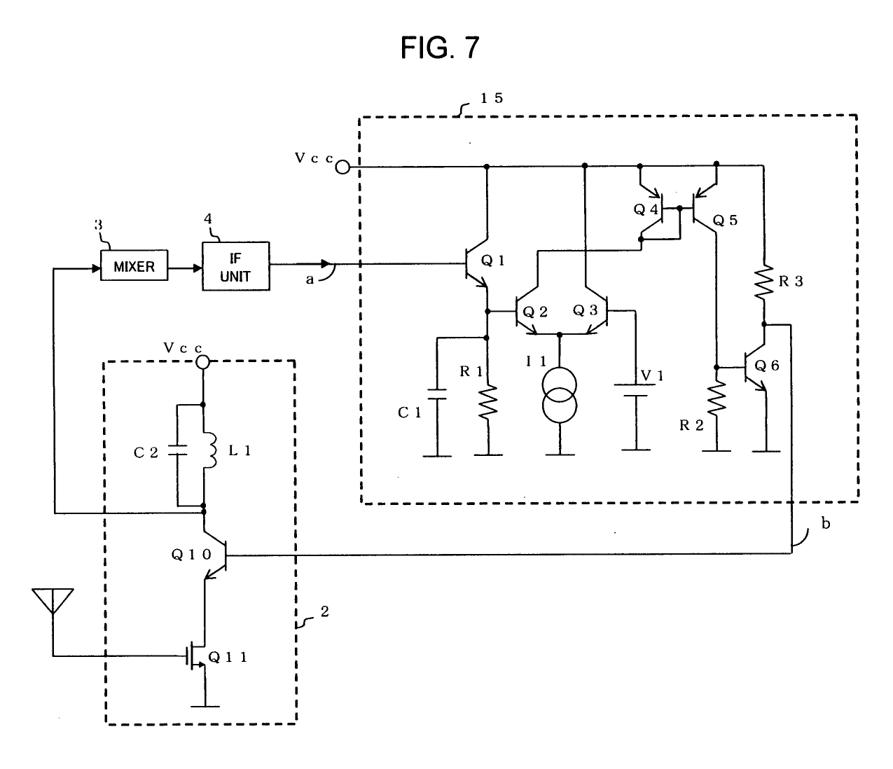

The detection of the amplitude level of an intermediate-frequency signal a, the output of an AGC control voltage b, and the amplification factor reducing operation of the RF amplifier 2 are the same as those described in the conventional technique shown in FIG. 7; however, the transistor Q7, which operates through the operation of the transistor Q4, is added and a DC voltage is outputted as a RFAGC monitor voltage c by flowing a current into the resistor R4 in response to a potential gradient at a comparator comprised of the transistors Q2 and Q3 and the constant-current source I1.

As shown in the conventional technique, when an AGC performance point has been reached at this time, the AGC control voltage b drops and at the same time, the RFAGC monitor voltage c rises from 0 volts.

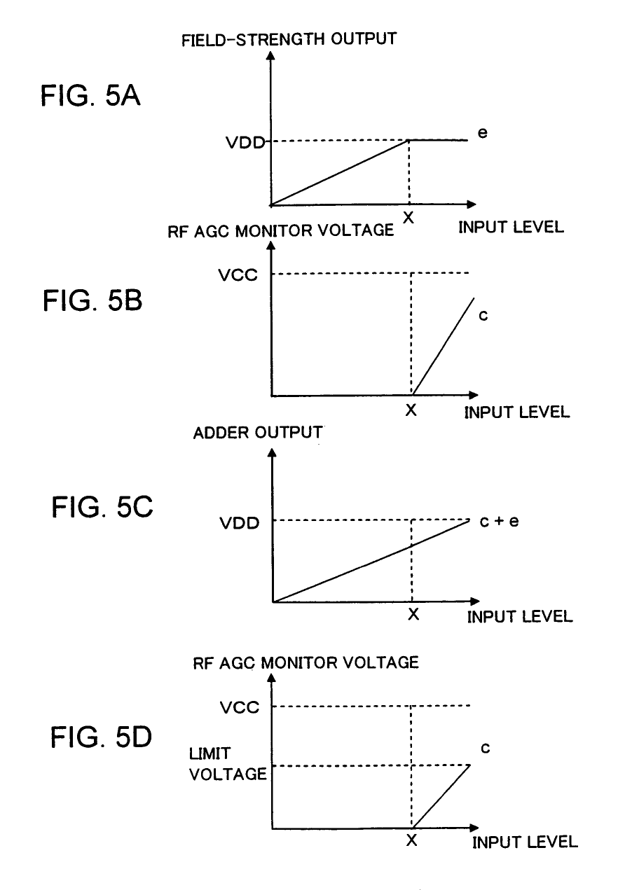

FIGS. 5A to 5D are graphs of the relationship between the antenna input level and the field-strength output, the relationship between the antenna input level and the adder output, and the relationship between the antenna input level and the RFAGC monitor voltage c.

The relationship between the antenna input level and the output voltage e at the field-strength meter 10 included in the digital IF circuit block 200 is shown in FIG. 5A (see FIG. 1). Since the field strength is detected based on the amplitude level of the intermediate-frequency signal a as in the case of the conventional technique, the field strength takes on a constant value through the RFAGC performance irrespective of the antenna input level. Incidentally, although the output voltage eat the field-strength meter 10 takes on a digital value, the description of the output voltage e is presented by regarding the voltage e as an analog voltage for the sake of convenience.

The relationship between the RFAGC monitor voltage c (see FIG. 1) and the antenna input level is shown in FIG. 5B. At the input level above a value X at which the RFAGC performance is started, a DC voltage corresponding to the input level is outputted as the RFAGC monitor voltage c.

The relationship between the antenna input level and the output of the field-strength output terminal 13 (see FIG. 1), i.e., the adder output is shown in FIG. 5C. As the adder output, a value is outputted which is obtained by adding the RFAGC monitor voltage c to the voltage e corresponding to a field strength detected at the digital IF circuit block 200. As shown in FIG. 5C, the field strength maintains a predetermined gradient to the input level even at the time of the reception of a high input during which RFAGC is performed.

In the AM radio receiver according to this embodiment comprised of the analog RF circuit block 100 and the digital IF circuit block 200, by adding the RFAGC monitor voltage c to the output voltage e from the field-strength meter 10, the linearity of the field strength to the antenna input level is secured and the antenna input level can be determined by the field-strength meter 10 irrespective of RFAGC performance, thereby the sensitivity of its automatic channel selecting function is improved.

Incidentally, it is needless to say that the RFAGC monitor voltage c and the output voltage e from the field-strength meter 10 are added up in the form of digital values.

### Second Embodiment

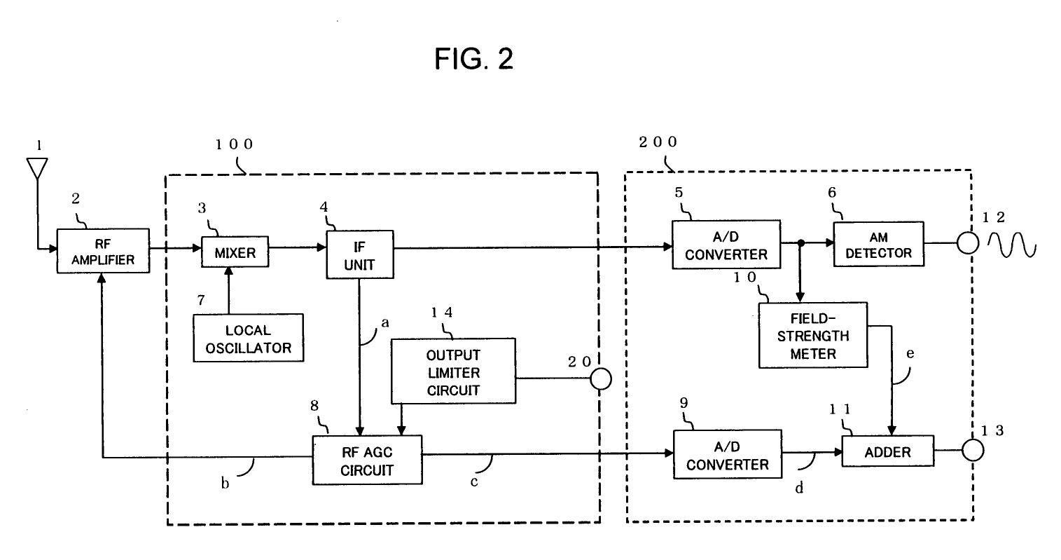

FIG. 2 is a block diagram of the configuration of an AM radio receiver according to a second embodiment of the invention. Components which are the same as those described in the conventional technique and shown in FIG. 1 are denoted by using the same reference numerals.

As shown in FIG. 2, the AM radio receiver comprises the analog RF circuit block 100, the digital IF circuit block 200, the antenna 1, the RF amplifier 2, the mixer 3, the IF unit 4, the A/D converter 5 for intermediate-frequency signals, the AM detector 6, the local oscillator 7, the RFAGC circuit 8, the A/D converter 9, the field-strength meter 10, the adder 11, the AM audio signal output terminal 12, the field-strength output terminal 13, and an output limiter circuit 14.

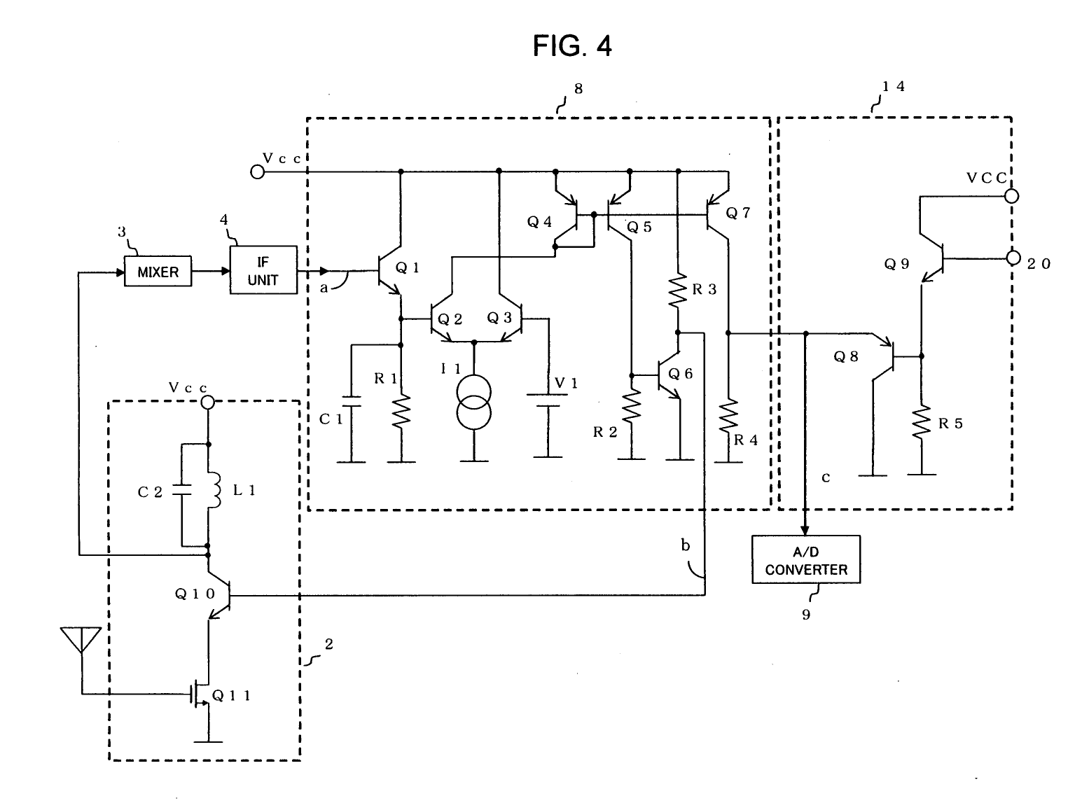

As shown in FIG. 2, the radio receiver has the output limiter circuit 14 which is annexed to the RFAGC circuit 8 of the radio receiver according to the first embodiment shown in FIG. 1. The operation of the radio receiver according to the second embodiment will be described below with reference to FIG. 4 and voltage outputted is shown in FIG. 5D.

As in FIG. 3, FIG. 4 shows concrete examples of the RFAGC circuit 8, the RF amplifier 2 and the output limiter circuit 14. In addition, a limit voltage input terminal 20, a resistor R5, and transistors Q8 and Q9 are added to the configuration of FIG. 3.

According to the configuration of FIG. 4, when the amplitude level of an intermediate-frequency signal a heightens, the transistor Q7 is turned on as in the case of the RFAGC circuit 8 of FIG. 3 and a RFAGC monitor voltage c rises. When the RFAGC monitor voltage c is low, the transistor Q8 is in the off state; however, when the RFAGC monitor voltage c reaches a limit voltage at the limit voltage input terminal 20, the transistor Q8 is turned on and part of a current flowing into the resistor R4 flows to the transistor Q8. As a result, the RFAGC monitor voltage c is limited with the voltage at the limit voltage input terminal 20.

Through the provision of the above limit function, the RFAGC monitor voltage c ranges between 0 volts and the limit voltage as shown in FIG. 5D. The limit voltage is desirably fed by using the power supply VDD for the A/D converter and can also be fed in the form of a constant voltage generated in the analog RF circuit block 100.

According to this embodiment, the limitation placed on the RFAGC monitor voltage c makes it possible to avoid problems such as malfunction and withstand voltage resulting from the excess of an input voltage to the A/D converter 9 over the power supply voltage VDD. The other advantages are the same as those described in the first embodiment.

### INDUSTRIAL APPLICABILITY

The AM radio receiver according to the present invention is useful as an AM radio receiver which comprises the analog RF circuit block and the digital IF circuit block and which is required to have an improved sensitivity to the detection of a desired broadcasting station.

1. An AM receiver comprising:
a RF amplifier which amplifies a signal received by an antenna;
a mixer which converts the amplified signal outputted by the RF amplifier to an intermediate-frequency signal;
an IF unit which filters and amplifies the intermediate-frequency signal;
a first A/D converter which converts the amplified signal outputted by the IF unit to an intermediate-frequency digital signal;
an AM detection circuit which outputs an AM audio signal based on the output signal from the first A/D converter;
a field-strength meter which converts the output signal from the first A/D converter to a first digital value corresponding to a DC voltage commensurate with the level of the intermediate-frequency signal;
a RFAGC control circuit which combines a RFAGC function for use in controlling an attenuation amount at the RF amplifier in response to the level of the intermediate-frequency signal and a RFAGC monitor function for use in outputting a RFAGC monitor voltage which indicates the status of RFAGC performance;
a second A/D converter which converts the RFAGC monitor voltage into a second digital value;
an adder which adds the first digital value outputted from the field-strength meter and the second digital value outputted from the second A/D converter; and
a terminal which outputs the result of the addition performed by the adder as an AM field-strength output.

2. The AM receiver according to claim 1, wherein a maximum output limiter which limits the maximum value of the RFAGC monitor voltage is provided between the RFAGC monitor voltage output unit of the RFAGC control circuit and the second A/D converter.
